(19) United States
(12) Patent Application Publication
(10) Pub. No.: US 2021/0078760 A1
(43) Pub. Date: Mar. 18, 2021

(54) DISPLAY READY CASE AND BLANK FOR FORMING THE SAME

(71) Applicant: Fallas Automation, Inc., Waco, TX (US)

(72) Inventors: Mark McAninch, Lorena, TX (US); James Norris, Waco, TX (US); Daniel Maeyaert, Waco, TX (US); Jacob Cox, China Springs, TX (US)

(73) Assignee: Fallas Automation, Inc., Waco, TX (US)

(21) Appl. No.: 16/668,722

(22) Filed: Oct. 30, 2019

Related U.S. Application Data
(60) Provisional application No. 62/901,349, filed on Sep. 17, 2019.

(51) Int. Cl. B65D 5/54; B65D 5/20; B31B 50/00; B31B 50/10; B31B 50/25; B31B 50/26; B31B 50/74

(52) U.S. Cl. CPC B65D 5/5475; B65D 5/2076; B31B 50/006; B31B 50/74; B31B 50/25; B31B 50/262; B31B 50/10

(57) ABSTRACT

A blank for forming a display ready case includes a front panel, a top panel, a rear panel, a bottom panel, and a bottom end panel arranged in a longitudinal direction and coupled together by a plurality of fold lines extending in a transverse direction. A first front side panel and a second front side panel extend from opposing sides of the front panel in the transverse direction. A front end panel extends from the front panel in the longitudinal direction, and a first front end side panel and a second front end side panel extend from opposing sides of the front end panel in the transverse direction. An access region separates the front panel from the front end panel. A line of weakness separates the first front side panel and the second front side panel from the first front end side panel and the second front end side panel.

### RELATED APPLICATION

This application claims the benefit of U.S. Provisional Application No. 62/901,349, filed on Sep. 17, 2019, pending, the entirety of which is incorporated herein by reference.

### TECHNICAL FIELD

The present disclosure generally relates to a case or container suitable for use in storing and shipping a plurality of articles, a portion of which may be removed and discarded in order to display articles contained therein, and in particular, to a display ready case and a blank for forming the same.

### BACKGROUND

Shipping packages, such as corrugated, cardboard and/or paperboard boxes, trays and similar assemblies are commonly used to contain a plurality of articles for transport of such articles from the manufacturer to their eventual retail environment. Upon arrival in a retail environment it is desirable to store or display these articles on shelves so that the articles are conveniently visible and accessible by a consumer. Thus, some package assemblies have been designed to be convertible from a shipping configuration to a display configuration, also known as display ready packaging.

Such containers are usually formed from blanks of sheet material that are folded along preformed fold lines to form an erected corrugated case or container. At least some known blanks include a pair of side panels, a top panel, a bottom panel, a plurality of end panels, and, in some cases, a glue tab, connected by a plurality of fold lines. The panels are rotated to form end walls, side walls, a bottom wall, and a top wall of the container. To form at least some known containers, some of the panels are secured using an adhesive. Such known containers are formed using a machine and/or by hand.

At least some known containers that are used to transport and/or store articles may be stacked one on the other when the articles are being transported or stored. The side walls of the containers on the lower layers of the stack are configured to support a weight of the containers on the upper layers of the stack. In addition, at least some known containers include lines of weakness through at least one side wall to facilitate separating a top portion of the container from a bottom display or tray portion of the container after arrival at a retail facility. However, the lines of weakness in the side walls may reduce the stacking strength, causing articles within the lower container(s) to support the weight of the upper layers. As such, the articles within the containers may be damaged during transport and/or storage.

At least some known containers attempt to improve the structural integrity of such containers by including additional or redundant panels or tabs within the container intended to connect and secure (e.g., via adhesive) the top portion of the container to the bottom display or tray portion. These additional panels or tabs may themselves include a line of weakness to facilitate separating the top portion of the container from the bottom portion. However, the inclusion of such additional panels or tabs reduces the ease of separating the top potion of the container from the display portion of the container, and leaves unsightly remains of the panels or tabs following separation. Moreover, the adhesive holding these panels or tabs in place are susceptible to breaking loose when stacked, potentially rendering the case (and the articles contained therein) unusable.

Despite the plethora of unique convertible package assembly/display systems that are available, there remains a need for improved systems that are even more dynamically useful, environmentally friendly and cost effective.

### BRIEF SUMMARY

In one aspect, a blank for forming a display ready case includes a front panel, a top panel, a rear panel, a bottom panel, and a bottom end panel arranged in a longitudinal direction and coupled together by a plurality of generally parallel fold lines extending in a transverse direction. A first front side panel and a second front side panel extend from opposing sides of the front panel in the transverse direction. A front end panel extends from the front panel in the longitudinal direction, and a first front end side panel and a second front end side panel extend from opposing sides of the front end panel in the transverse direction. An access region separates the front panel from the front end panel, and a line of weakness separates the first front side panel and the second front side panel from the first front end side panel and the second front end side panel.

The access region may extend from the first front side panel to the second front side panel. Alternatively, the blank may also include a first slit extending from the access region to the first front side panel, and a second slit extending from the access region to the second front side panel.

A first fold line extending in the longitudinal direction may separate the front panel from the first front side panel, and the front end panel from the first front end side panel, while a second fold line extending in the longitudinal direction may separate the front panel from the second front side panel, and the front end panel from the second front end side panel.

The blank may also include a plurality of corrugations extending in the longitudinal direction.

A size and shape of the front end panel may be the same as a size and shape of the bottom end panel.

The blank may also include a first rear side panel and a second rear side panel extending from opposing sides of the rear panel in the transverse direction. A second line of weakness may extend through the first rear side panel, the rear panel, and the second rear side panel. The blank may also include a second access region located in the rear panel, wherein the second line of weakness runs through the second access region.

The blank may also include a first top side panel and a second top side panel extending from opposing sides of the top panel in the transverse direction, and a first bottom side panel and a second rear bottom side panel extending from opposing sides of the bottom panel in the transverse direction. The blank may be characterized by the absence of a line of weakness in the top panel, the first top side panel, the second top side panel, the bottom panel, the first bottom side panel, and the second bottom side panel.

In another aspect, a blank for forming a display ready case, includes a front panel, a top panel, a rear panel, and a bottom panel arranged in a longitudinal direction and coupled together by a plurality of generally parallel fold lines extending in a transverse direction. A first front side panel and a second front side panel extends from opposing sides of the front panel in the transverse direction, and a front end panel extends from the front panel in the longitudinal direction. An access region extends from the first front side panel to the second front side panel and separates the front panel from the front end panel.

The blank may also include a first front end side panel and a second front end side panel extending from opposing sides of the front end panel in the transverse direction. A line of weakness may separate the first front side panel and the second front side panel from the first front end side panel and the second front end side panel.

A first fold line extending in the longitudinal direction may separate the front panel from the first front side panel, and the front end panel from the first front end side panel, while a second fold line extending in the longitudinal direction may separate the front panel from the second front side panel, and the front end panel from the second front end side panel.

The blank may also include a plurality of corrugations extending in the longitudinal direction.

The blank may also include a bottom end panel extending from the bottom panel in the longitudinal direction and coupled to the bottom panel by a fold line extending in the transverse direction. A size and shape of the front end panel may be the same as a size and shape of the bottom end panel.

The blank may also include a first rear side panel and a second rear side panel extending from opposing sides of the rear panel in the transverse direction. A second line of weakness may extend through the first rear side panel, the rear panel, and the second rear side panel. The blank may also include a second access region located in the rear panel. The second line of weakness may run through the second access region.

The blank may also include a first top side panel and a second top side panel extending from opposing sides of the top panel in the transverse direction, and a first bottom side panel and a second rear bottom side panel extending from opposing sides of the bottom panel in the transverse direction. The blank may be characterized by the absence of a line of weakness in the top panel, the first top side panel, the second top side panel, the bottom panel, the first bottom side panel, and the second bottom side panel.

In another aspect, a display ready case includes: a front panel, and a first front side panel and a second front side panel generally perpendicular to and extending from opposing sides of the front panel; a top panel, and a first top side panel and a second top side panel generally perpendicular to and extending from opposing sides of the top panel; a rear panel, and a first rear side panel and a second rear side panel generally perpendicular to and extending from opposing sides of the rear panel; a bottom panel, and a first bottom side panel and a second bottom side panel generally perpendicular to and extending from opposing sides of the bottom panel; a front end panel, and a first front end side panel and a second front end side panel generally perpendicular to and extend from opposing sides of the front end panel; and, a bottom end panel. A top portion of the display ready case is at least partially separable from a bottom portion of the display ready case along a first line of weakness extending through the rear panel, the first rear side panel, and the second rear side panel, and along a second line of weakness separating the first front side panel and the second front side panel from the first front end side panel and the second front end side panel.

An access region may extend from the first front side panel to the second front side panel and at least partially separate the front panel from the front end panel.

The bottom portion may include the bottom panel, the first bottom side panel, the second bottom side panel, the bottom end panel, the front end panel, the first front end side panel, and the second front end side panel.

### BRIEF DESCRIPTION OF THE DRAWINGS

FIG. 1 is a top view of a blank for forming a display ready case of the present disclosure;

FIG. 2 is a perspective view of the blank of FIG. 1, illustrating a first step for forming the display ready case;

FIG. 3 is a perspective view of the blank of FIG. 2, following a subsequent step for forming the display ready case;

FIG. 4 is a perspective view of the blank of FIG. 3, following a subsequent step for forming the display ready case;

FIG. 5 is a perspective view of the blank of FIG. 4, following a subsequent step for forming the display ready case, prior to the loading of articles therein;

FIG. 6 is a perspective view of the blank of FIG. 5, illustrating the loading of articles therein;

FIG. 7 is a perspective view of the blank of FIG. 6, after the loading of articles therein, illustrating a subsequent step for forming the display ready case;

FIG. 8 is a perspective view of the blank of FIG. 7, after the loading of articles therein, illustrating a subsequent step for forming the display ready case;

FIG. 9 is a perspective view of the blank of FIG. 8, after the loading of articles therein, illustrating a subsequent step for forming the display ready case, and illustrating a suitable shipping orientation of the display ready case; and,

FIG. 10 is a perspective view of the display ready case of FIG. 9, illustrating movement of the display ready case into a display orientation, and separation of a top portion of the display ready case from a bottom portion, revealing the articles therein.

### DETAILED DESCRIPTION OF THE PRESENTLY PREFERRED EMBODIMENTS

While a display ready case of the present disclosure may be embodied in many different forms, there is described in detail herein a specific exemplary embodiment. This description is an exemplification of the principles of the invention and is not intended to limit the invention to the particular illustrated embodiment.

The embodiment described herein provides a stackable, convertible display ready case formed from a blank, and a method for constructing the same. The blank is constructed from sheet material. The display ready case may be constructed from sheet material using a machine and/or by hand. In one embodiment, the blank is fabricated from a corrugated cardboard material. The blank, however, may be fabricated using any suitable material, and therefore is not limited to a specific type of material. In alternative embodiments, the blank is fabricated using cardboard, plastic, fiberboard, paperboard, foamboard, corrugated paper, and/or any suitable material known to those skilled in the art and guided by the teachings provided herein.

In some embodiments, the display ready case and/or a blank includes at least one marking thereon including, without limitation, indicia that communicates the product, a manufacturer of the product and/or a seller of the product. For example, the marking may include printed text that indicates a product's name and briefly describes the product, logos and/or trademarks that indicate a manufacturer and/or seller of the product, and/or designs and/or ornamentation that attract attention. In another embodiment, the container is void of markings, such as, without limitation, indicia that communicates the product, a manufacturer of the product and/or a seller of the product.

Furthermore, the display ready case may have any suitable size, shape and/or configuration, i.e., any suitable number of sides having any suitable size, shape and/or configuration as described and/or illustrated herein. In one embodiment, the display ready case includes a shape that provides functionality, such as a shape that facilitates packaging a food item, a shape that facilitates transporting the display ready case, and/or a shape that facilitates stacking and/or arrangement of a plurality of display ready cases.

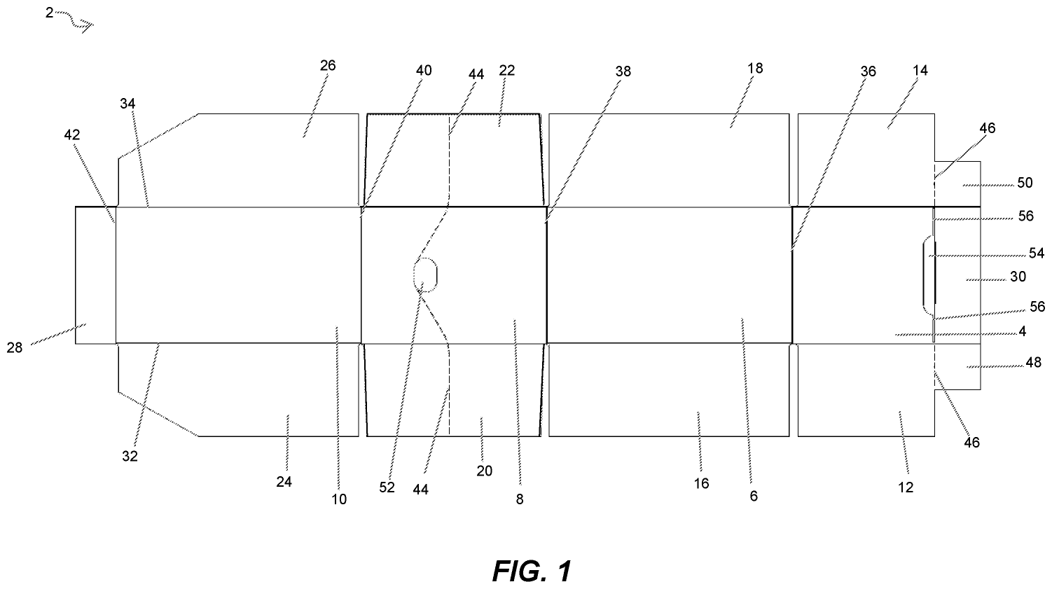

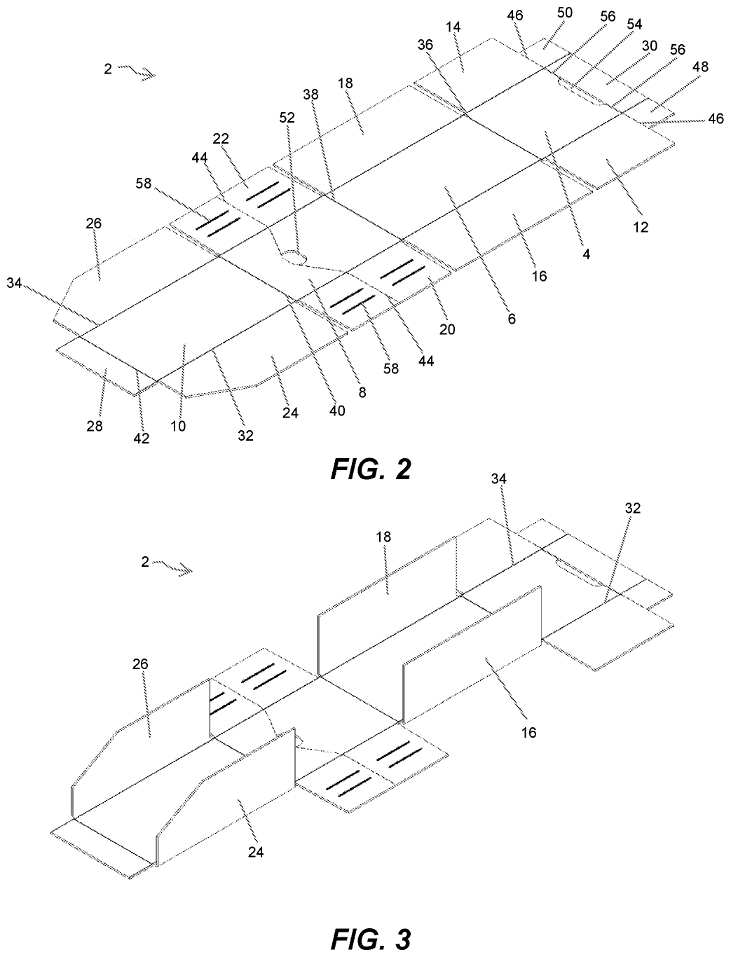

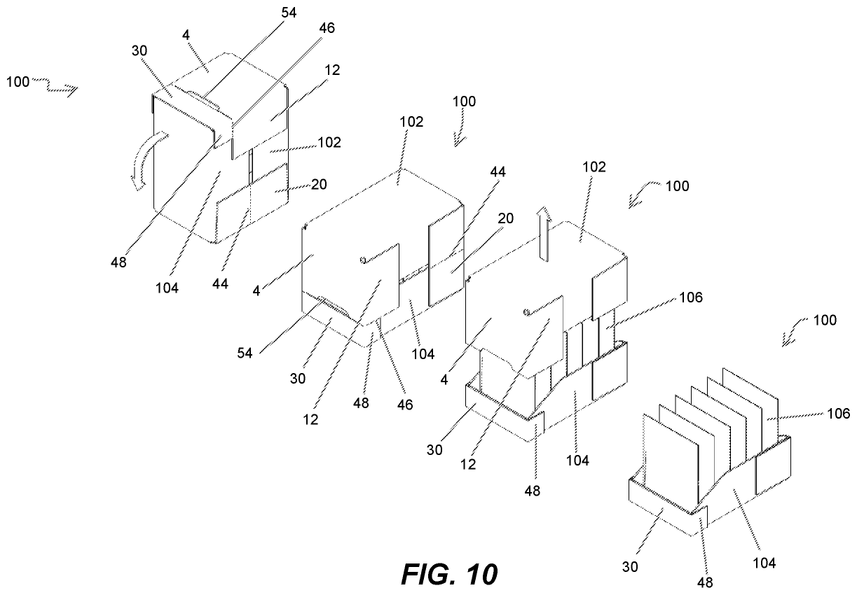

Referring now to the drawings, FIGS. 1-2 are a top view and a perspective view, respectively, of a blank 2 according to the present disclosure. The blank 2 is used to form a display ready case 100 according to the present disclosure, illustrated in FIG. 9 in a suitable shipping orientation, and in FIG. 10 in a display orientation, prior to, during, and following removal of a top portion 102 of the display ready case 100 from a bottom or tray portion 104 of the display ready case 100, thereby revealing a plurality of articles 106 contained therein.

As shown in FIGS. 1-2, the blank 2 includes a series of aligned main panels, side panels, and end panels connected together by a plurality of preformed, generally parallel, fold lines. Specifically, the main panels include a front panel 4, a top panel 6, a rear panel 8, and a bottom panel 10. The side panels include a first front side panel 12, a second front side panel 14, a first top side panel 16, a second top side panel 18, a first rear side panel 20, a second rear side panel 22, a first bottom side panel 24, and a second bottom side panel 26. The end panels include a front end panel 28 and a bottom end panel 30. It should be appreciated that designations such as “side,” “end,” “top,” “bottom,” “front,” and “rear” are used for explanatory purposes only, particularly with reference to the orientations of the panels when the display ready case 100 is in a display orientation, as shown in FIG. 10. Such designations do not impose orientation requirements on the display ready case 100 except as expressly stated herein.

The plurality of preformed fold lines include generally parallel longitudinal fold lines 32, 34, and generally parallel transverse fold lines 36, 38, 40, 42. The generally parallel longitudinal fold lines 32, 34 are generally perpendicular to the generally parallel transverse fold lines 36, 38, 40, and 42. It will be appreciated that the position of the fold lines 32, 34, 36, 38, 40, and 42 illustrated herein are exemplary, and that precise location of the fold lines 32, 34, 36, 38, 40, and 42 may be adjusted to aid in the forming of the display ready case 100.

The blank 2 further includes a plurality of lines of weakness, represented by dashed lines. Specifically, a first line of weakness 44 is formed through rear panel 8, first side panel 20, and second side panel 22. As illustrated, the first line of weakness 44 extends through the first rear side wall 20 and the second rear side panel 22 in a direction generally parallel to transverse fold lines 38, 40, and through the rear panel 8 in multiple directions angled or cured relative to the transfer fold lines 38, 40. In alternative embodiments, the first line of weakness 44 may extend through rear panel 8, first side panel 20, and second side panel 22 in a manner such that the entire line of weakness 44 is parallel to transverse fold lines 38, 40. Alternatively, the line of weakness 44 may be angled relative to the transverse fold lines 38, 40, including for example, through select portions of the line of weakness 44 (e.g., within the first rear side panel 20 and the second rear side panel 22). It will be appreciated that the orientation of the line of weakness 44 may impart different aesthetic appearances of the display ready case 100 when the top portion 102 is separated from the bottom portion 104 of the display read case, as shown in FIG. 10.

A second line of weakness 46 is formed between the front panel 4, the first front side panel 12, and the second front side panel 14, on the one hand, and the front end panel 30, on the other hand. As used herein, the term “line of weakness” refers to any preformed line, such as but not limited to score lines, perforation lines, or lines of separation along which the blank material is configured to have a relatively decreased resistance to tearing, and/or to any other suitable separation mechanism. For example, but not by way of limitation, a pull strip or zipper rule may be located along line of weakness 44.

In general, the longitudinal fold lines 32, 34, and transverse fold lines 36, 38, 40, 42 define the size and shape of the font panel 4, top panel 6, rear panel 8, bottom panel 10, bottom end panel 28 and font end panel 30. In addition, the line of weakness 46, in combination with the transverse parallel fold lines 32, 34, define a first front end side panel 48 and a second front end side panel 50. As illustrated, first front side panel 12, second front side panel 14, first top side panel 16, second top side panel 18, first rear side panel 20, second rear side panel 22, bottom end panel 28, front end panel 30, first front end side panel 48, and second front end side panel 50 are generally square or rectangular, while first bottom side panel 24 and second bottom side panel 26 are five-sided, or pentagonal. In alternative embodiments, these side panels and end panels may have any number of shapes and/or dimensions that enable the blank 2 and a display ready case constructed therefrom to function as described herein. For example, in some embodiments, the outer corners of the side panels and the end panel may be chamfered. It will be appreciated that shapes and/or dimensions of the side panels and end panels may impart different aesthetic appearances of the display ready case 100 when the top portion 102 is separated from the bottom portion 104 of the display ready case 104, as shown in FIG. 10.

The blank 2 may further include one or more access regions. Specifically, the blank 2 includes a first access region 52 formed in the rear panel 8, and a second access region 54 formed in the front panel 4. As used herein, the term “access region” refers to either a cavity or hole formed in the blank, or a region or area of weakness that can be punched-out by a user to form a cavity or hole. As illustrated, the first access region 52 is generally elliptical or oblong, and is positioned in the rear panel 8 such that the line of weakness 44 runs through the first access region 52. In this way, an individual may grasp the first access region 52 to aid in the separation of the top portion 102 for the display ready case 100 from the bottom portion 104. The second access region 54 is generally elongated, and is positioned in the front panel 4, adjacent the front end panel 30. Notably, the second access region 54 includes slits or channels 56 formed in the front panel 4, or at the boundary of the front panel 4 and the front end panel 30, that extend from the central portion of the second access region 54 to, or at least in the vicinity of, the longitudinal fold lines 32, 34. As illustrated, the second access region 54 and the slits or channels 56 are aligned with the second line of weakness 46. In this way, an individual may grasp the second access region 54 to aid in the separation of the front panel 4, the first front side panel 12, and the second front side panel 14, on the one hand, from the front end panel 30, first front end side panel 48, and second front end side panel 50, on the other hand, when the display ready case 100 is fully formed. In alternative embodiments, the slits or channels 56 formed with the second access region 54 may be replaced with a line of weakness (e.g., such that the second line of weakness 46 extends through the second access region 54). In alternative embodiments, the blank 2 may include one or more access regions in any suitable number, location, shape, size and/or configuration that enables the blank 2 and the display ready case 100 to function as described herein. For example, in alternative embodiments, one ore more access regions may be located adjacent to one of the transverse fold lines 32, 38, 50 and/or 42.

In the exemplary embodiment, the blank 2 is fabricated from a corrugated cardboard material and includes a plurality of corrugations or flutes (not shown) therein, oriented in the longitudinal direction (i.e., parallel to the longitudinal fold lines 32, 34). As described further herein, this arrangement facilities improved stacking strength for then blank 2 when erected into the display ready case 100, and oriented in the shipping orientation illustrated in FIG. 9.

The process for forming the display ready case 100 from the blank 2 will now be described, beginning with references to FIG. 2. Specifically, a plurality of strips of adhesive 58 are applied to the first rear panel 20 and the second rear panel 22, as illustrated. It should be appreciated that the strips of adhesive 58 may comprise any suitable type of adhesive, and may be applied in any suitable manner, quantity, shape, any/or location that enables the blank 2 and the display ready case 100 to function as described herein

In a subsequent step, referring to FIG. 3, the first top side panel 16 and the first bottom side panel 24 are folded along longitudinal fold line 32, as illustrated. Likewise, the second top side panel 18 and the second bottom side panel 26 are folded along longitudinal fold line 34, as illustrated.

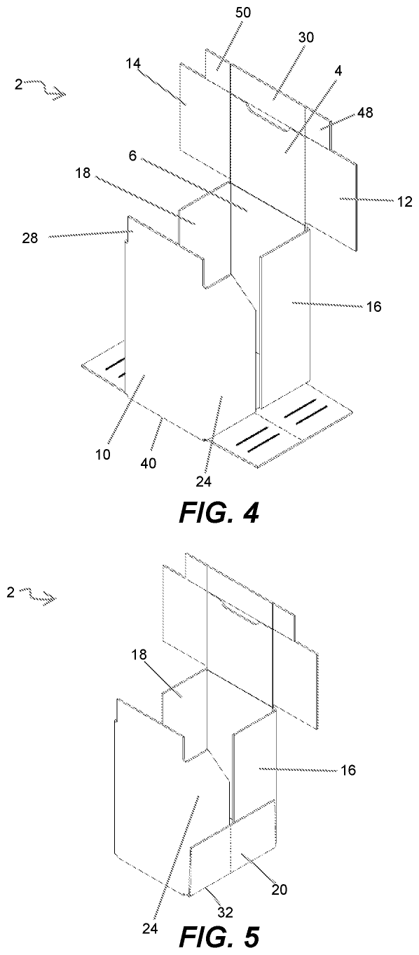

In a subsequent step, referring to FIG. 4, the top panel 6 (including the first stop side panel 16 and the second top side panel 18), the front panel 4 (including the first front side panel 12 and the second front side panel 14), and the front end panel 30 (including the first front end side panel 48 and the second front end side panel 50) are folded along transverse fold line 38 (not visible in FIG. 4), as illustrated. Likewise, the bottom panel 10 (including the first bottom side panel 24 and the second bottom side panel 26 (not visible in FIG. 4)), and the bottom end panel 28 are folded along transverse fold line 40.

In a subsequent step, referring to FIG. 5, the first rear side panel 20 is folded along longitudinal fold line 32, as illustrated, toward the first top side panel 16 and the first bottom side panel 24, such that the strips of adhesive 58 (visible in FIG. 4) adhere the first rear side panel 20 to the first stop side panel 16 and the first bottom side panel 24. Likewise, the second rear side panel 22 (not visible in FIG. 4) is folded along longitudinal fold line 34 (not visible in FIG. 4), as illustrated, toward the second stop side panel 18 and the second bottom side panel 26 (not visible in FIG. 4), such that the strips of adhesive 58 (visible in FIG. 4) adhere the second rear side panel 22 to the second top side panel 18 and the second bottom side panel 26.

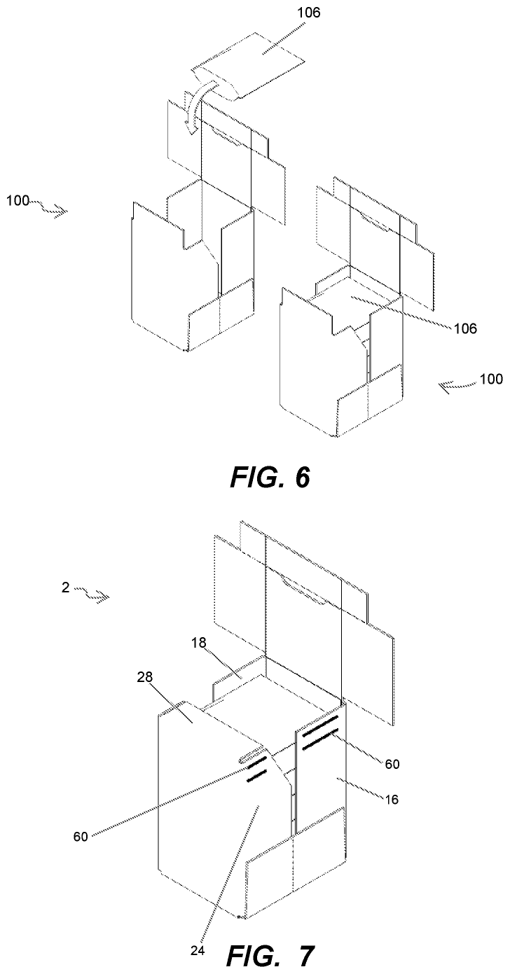

In a subsequent step, referring to FIG. 6, a plurality of articles 106 are loaded into the partially formed display ready case 100. As illustrated, the plurality of articles 106 may be stacked, for example, by a robotic arm of a case packing system (not shown), in an orientation with the front face of the articles 106 facing upward, when the display read case 100 is in a suitable shipping orientation (as shown in FIG. 9), or forward, when the display ready case is in a display orientation (as shown in FIG. 10). It will be appreciated that the plurality of articles 106 may be arranged as a single stack of articles 106, as shown, or alternatively, in the situation of a larger display ready case 100, and/or narrower articles 106, in two or more stacks of articles 106 arranged side by side.

In a subsequent step, referring to FIG. 7, the bottom end panel 28 is folded along transverse fold line 42, as illustrated. In addition, a plurality of strips of adhesive 60 are applied to the first bottom side panel 24 and the first top side panel 16, as illustrated. Likewise, a plurality of strips of adhesive 60 (not visible in FIG. 7) are applied to the second bottom side panel 26 (not visible in FIG. 7) and the second top side panel 18. It should be appreciated that the strips of adhesive 60 may also comprise any suitable type of adhesive, and may be applied in any suitable manner, quantity, shape, any/or location that enables the blank 2 and the display ready case 100 to function as described herein.

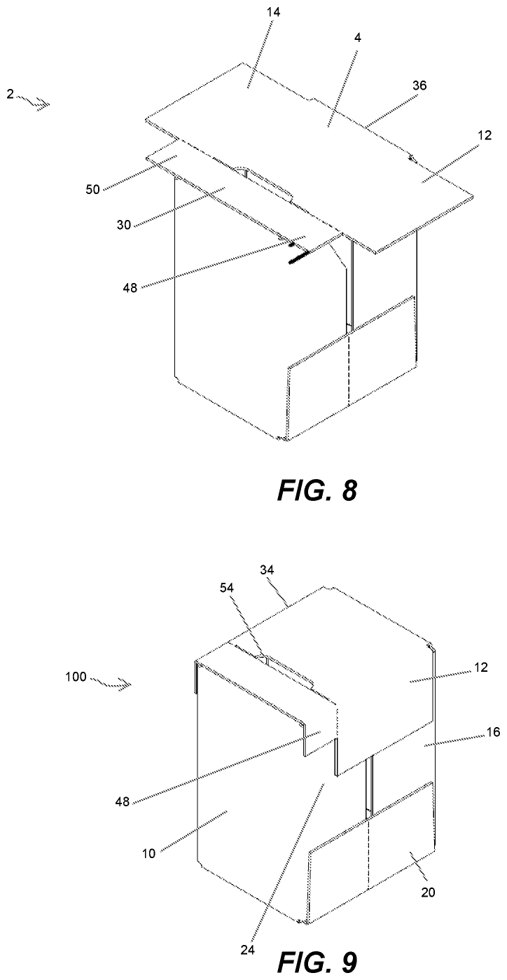

In a subsequent step, referring to FIG. 8, the front panel 4 (including the first front side panel 12 and the second front side panel 14) and the front end panel 30 (including the first front end side panel 48 and the second front end side panel 50) are folded along transverse fold line 36, as illustrated.

In a subsequent step, referring to FIG. 9, the first front side panel 12 and the first front end side panel 48 are folded along longitudinal fold line 32, as illustrated, respectively toward the first top side panel 16 and the first bottom side panel 24, such that the strips of adhesive 60 (visible in FIG. 7) adhere the first front side panel 12 to the first top side panel 16, and the first front end side panel 48 to the first bottom side panel 24. Likewise, the second front side panel 14 and the second front end side panel 50 (not visible in FIG. 9) are folded along longitudinal fold line 34, as illustrated, respectively toward the second top side panel 18 and the second bottom side panel 26 (not visible in FIG. 9), such that the strips of adhesive 60 (not visible in FIG. 9) adhere the second front side panel 14 to the second top side panel 18, and the second front end side panel 50 to the second bottom side panel 26.

Following the step illustrated in FIG. 9, the display ready case 100 is fully formed. In FIG. 9, the display ready case 100 is illustrated in one suitable shipping orientation, such that the display ready case 100 may be stacked with and/or below other display ready cases, or other items, including for example, on a shipping pallet, or on shelving in a storage center or retail outlet. Notably, the top panel 6 (not visible in FIG. 9), the first top side panel 16, and the second top side panel 18 (not visible in FIG. 9), as well as the bottom panel 10, the first bottom side panel 24, and the second bottom side panel 26 (not visible in FIG. 9), comprise solid, uninterrupted corrugated panels having a plurality of corrugations or flutes (not shown) extending the height of the display ready case 100 when in the shipping orientation. In this shipping orientation, the above configuration provides increased columnar strength and crush resistance of the display ready case 100, allowing for increased stacking and/or use of a thinner, cheaper, and/or more environment friendly material for forming the blank 2.

As shown in the exemplary display ready case 100 of FIG. 9, the first front side panel 12, the first top side panel 16, the first rear side panel 20, and the first bottom side panel 24 are also shaped and sized to expose minimal access to the articles 106 contained in the display ready case 100. Likewise, the second front side panel 14 (not visible in FIG. 9), the second top side panel 18 (not visible in FIG. 9), the second rear side panel 22 (not visible in FIG. 9), and the second bottom side panel 26 (not visible in FIG. 9) are shaped and sized to expose minimal access to the articles 106 contained in the display ready case 100. That is, in this shipping orientation, there are no gaps on the sides of the display ready case 100 sufficient for the articles 106 to stick through. In general, the only gaps in the display ready case 100 are those formed by the first access region 52 (not visible in FIG. 9) and the second access region 54, thereby protecting the articles 106 contained in the display ready case 100.

As illustrated in FIG. 10, the display ready case 100 may be rotated from the shipping orientation to a display orientation, wherein the articles 106 in the display ready case 100 stand upright, such that the front face of the articles 106 faces the front panel 4 of the display ready case 100. Notably, the front panel 4, the first front side panel 12, the second front side panel 14 (not visible in FIG. 10), the first front end panel 30, the first front end side panel 48, and the second front end side panel 50 (not visible in FIG. 10) are shaped and cooperate to provide a full corrugate connection (interrupted only by the second access region 54) having a plurality of corrugations or flutes (not shown) extending the height of the display ready case 100, when in the display orientation. Likewise, the rear panel 8 (not visible in FIG. 10), the first rear side panel 20, and the second rear side panel 22 (not visible in FIG. 10), are shaped and cooperate to provide a full corrugate connection (interrupted only by the first access region 52) having a plurality of corrugations or flutes (not shown) extending the height of the display case 100, when in the display orientation. Again, this configuration provides increased columnar strength and crush resistance of the display ready case 100, allowing for increased stacking in the display orientation and/or use of a thinner, cheaper, and/or more environment friendly material for forming the blank 2. In this way, the display orientation shown in FIG. 10 may also serve as a suitable shipping orientation.

In the display orientation, an individual may grasp one or more of the first access region 52 and/or the second access region 54 (not visible in FIG. 9) to separate the top portion 102 of the display ready case 100 from the bottom portion 104. By pulling the top portion 102 and the bottom portion 104 of the display ready case 100 away from one another, an individual may separate the top portion 102 from the bottom portion 104, more specifically, by tearing the rear panel 8 (not visible in FIG. 9), the first rear side panel 20, and the second rear side panel 22 (not visible in FIG. 9) along the first line of weakness 44, and by tearing front panel 4, the first front side panel 12, and the second front side panel 14, from the front end panel 30, the first front end side panel 48, and the second front end side panel 50, along the second line of weakness 46. As noted above, the slits or channels 56 formed with the second access region 54 may be replaced with a line of weakness. With the top portion 102 of the display ready case 100 separated from the bottom portion 104, the top portion 102 may be removed and discarded, revealing the articles 106 within the display ready case 100. Notably, following separation of the top portion 102 of the display ready case 100 for the bottom portion 104, the bottom portion 104 displays clean edges, and does not include unsightly remains of additional panels or tabs found in some known containers.

The foregoing description of the exemplary and other embodiments is not intended to limit or restrict the scope or applicability of the inventive concepts conceived of by the Applicant. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicant desires all patent rights afforded by the appended claims. Therefore, it is intended that the appended claims include all modifications and alterations to the full extent that they come within the scope of the following claims or the equivalents thereof.

What is claimed:

1. A blank for forming a display ready case, the blank comprising:
a front panel, a top panel, a rear panel, a bottom panel, and a bottom end panel arranged in a longitudinal direction and coupled together by a plurality of generally parallel fold lines extending in a transverse direction;
a first front side panel and a second front side panel extending from opposing sides of the front panel in the transverse direction; and,
a front end panel extending from the front panel in the longitudinal direction, and a first front end side panel and a second front end side panel extending from opposing sides of the front end panel in the transverse direction;
wherein an access region separates the front panel from the front end panel; and,
wherein a line of weakness separates the first front side panel and the second front side panel from the first front end side panel and the second front end side panel.

2. The blank of claim 1, wherein the access region extends from the first front side panel to the second front side panel.

3. The blank of claim 1, further comprising a first slit extending from the access region to the first front side panel, and a second slit extending from the access region to the second front side panel.

4. The blank of claim 1, wherein a first fold line extending in the longitudinal direction separates the front panel from the first front side panel, and the front end panel from the first front end side panel, while a second fold line extending in the longitudinal direction separates the front panel from the second front side panel, and the front end panel from the second front end side panel.

5. The blank of claim 1, further comprising a plurality of corrugations extending in the longitudinal direction.

6. The blank of claim 1, wherein a size and shape of the front end panel is the same as a size and shape of the bottom end panel.

7. The blank of claim 1, further comprising a first rear side panel and a second rear side panel extending from opposing sides of the rear panel in the transverse direction, wherein a second line of weakness extends through the first rear side panel, the rear panel, and the second rear side panel.

8. The blank of claim 7, further comprising a second access region located in the rear panel, wherein the second line of weakness runs through the second access region.

9. The blank of claim 1, further comprising a first top side panel and a second top side panel extending from opposing sides of the top panel in the transverse direction, and a first bottom side panel and a second rear bottom side panel extending from opposing sides of the bottom panel in the transverse direction, wherein the blank is characterized by the absence of a line of weakness in the top panel, the first top side panel, the second top side panel, the bottom panel, the first bottom side panel, and the second bottom side panel.

10. A blank for forming a display ready case, the blank comprising:
a front panel, a top panel, a rear panel, and a bottom panel arranged in a longitudinal direction and coupled together by a plurality of generally parallel fold lines extending in a transverse direction;
a first front side panel and a second front side panel extending from opposing sides of the front panel in the transverse direction; and,
a front end panel extending from the front panel in the longitudinal direction;
wherein an access region extending from the first front side panel to the second front side panel separates the front panel from the front end panel.

11. The blank of claim 10, further comprising a first front end side panel and a second front end side panel extending from opposing sides of the front end panel in the transverse direction, wherein a line of weakness separates the first front side panel and the second front side panel from the first front end side panel and the second front end side panel.

12. The blank of claim 11, wherein a first fold line extending in the longitudinal direction separates the front panel from the first front side panel, and the front end panel from the first front end side panel, while a second fold line extending in the longitudinal direction separates the front panel from the second front side panel, and the front end panel from the second front end side panel.

13. The blank of claim 10, further comprising a plurality of corrugations extending in the longitudinal direction.

14. The blank of claim 10, further comprising a bottom end panel extending from the bottom panel in the longitudinal direction and coupled to the bottom panel by a fold line extending in the transverse direction, wherein a size and shape of the front end panel is the same as a size and shape of the bottom end panel.

15. The blank of claim 10, further comprising a first rear side panel and a second rear side panel extending from opposing sides of the rear panel in the transverse direction, wherein a second line of weakness extends through the first rear side panel, the rear panel, and the second rear side panel.

16. The blank of claim 15, further comprising a second access region located in the rear panel, wherein the second line of weakness runs through the second access region.

17. The blank of claim 10, further comprising a first top side panel and a second top side panel extending from opposing sides of the top panel in the transverse direction, and a first bottom side panel and a second rear bottom side panel extending from opposing sides of the bottom panel in the transverse direction, wherein the blank is characterized by the absence of a line of weakness in the top panel, the first top side panel, the second top side panel, the bottom panel, the first bottom side panel, and the second bottom side panel.

18. A display ready case comprising:
a front panel, and a first front side panel and a second front side panel generally perpendicular to and extending from opposing sides of the front panel;
a top panel, and a first top side panel and a second top side panel generally perpendicular to and extending from opposing sides of the top panel;
a rear panel, and a first rear side panel and a second rear side panel generally perpendicular to and extending from opposing sides of the rear panel;
a bottom panel, and a first bottom side panel and a second bottom side panel generally perpendicular to and extending from opposing sides of the bottom panel;
a front end panel, and a first front end side panel and a second front end side panel generally perpendicular to and extend from opposing sides of the front end panel; and,
a bottom end panel;
wherein a top portion of the display ready case is at least partially separable from a bottom portion of the display ready case along a first line of weakness extending through the rear panel, the first rear side panel, and the second rear side panel, and along a second line of weakness separating the first front side panel and the second front side panel from the first front end side panel and the second front end side panel.

19. The display ready case of claim 18, wherein an access region extending from the first front side panel to the second front side panel at least partially separates the front panel from the front end panel.

20. The display case of claim 18, wherein the bottom portion comprises the bottom panel, the first bottom side panel, the second bottom side panel, the bottom end panel, the front end panel, the first front end side panel, and the second front end side panel.
